(19) United States
(12) Patent Application Publication
(10) Pub. No.: US 2012/0208062 A1
(43) Pub. Date: Aug. 16, 2012

(54) LITHIUM SECONDARY CELL

(76) Inventors: Haoshen Zhou, Tsukuba-shi (JP); Yonggang Wang, Tsukuba-shi (JP)

(21) Appl. No.: 13/496,139

(22) PCT Filed: Dec. 18, 2009
(86) PCT No.: PCT/JP2009/071108

§ 371 Date: Mar. 14, 2012

(30) Foreign Application Priority Data
Dec. 26, 2008 (JP) 2008-331737

(51) Int. Cl. H01M 4/36

(52) U.S. Cl. 429/107; 429/105

(57) ABSTRACT

A lithium secondary cell, having: a negative electrode, a negative electrode-electrolyte solution, a separator, a positive electrode-electrolyte solution, and a positive electrode, which are disposed in this order, in which the separator is a solid electrolyte through which only lithium ions pass.

### TECHNICAL FIELD

The present invention relates to a lithium secondary cell utilizing a novel reaction.

### BACKGROUND ART

Hitherto many proposals of lithium secondary cells have been reported, and among these, only lithium ion secondary cells in which use is made of a combination of carbon/an organic electrolyte/a lithium-containing transition metal compound, have been specifically put into practical use.

As shown in FIG. 8, in those lithium ion secondary cells, in the case of charging, lithium ions contained in the lithium-containing transition metal compound that is a layer (lamellar) active material for a positive electrode are extracted from the positive electrode to become lithium ions, and the lithium ions are inserted into a layer carbon in a negative electrode. On the other hand, the cell has a structure that operates conversely in the case of discharging, that is, the lithium ions are extracted from the layer active material of the negative electrode and the lithium ions are then inserted in the transition metal compound that is a layer active material.

Thus, those lithium ion secondary cells enable charging and discharging by repeating insertion and extraction of lithium ions (Non-Patent Literature 1).

However, materials are limited, to which lithium ion can be inserted and which also enables extraction thereof. Specifically, there are few materials that enable insertion and extraction for a positive electrode, and active materials that have been put into practical use at present are only LiCoO₂, LiNiO₂, LiNi_{1/3}Mn_{1/3}Co_{1/3}O₂, LiMn₂O₄, LiFePO₄, LiMnPO₄, LiCoPO₄, and the like. Further, these active materials for a positive electrode each have a capacity of only about 20 mAh/g to 250 mAh/g, and the capacity thereof is small.

Further, conventional systems in which insertion and extraction are repeated have such a problem that volume expansion and breakage of the active material occur with the lapse of time, to shorten charge/discharge cycle lifetime.

Further, when metal lithium is used for the negative electrode, it is expected that the negative electrode has a capacity of 3,800 mAh/g that is about ten times that of currently-utilized carbon negative electrodes, but there is such a problem that a dendrite occurs due to dissolution and deposition of the metal lithium along with charging and discharging, and that the dendrite of lithium penetrates and collapses a separator of a polymer membrane, to cause short-circuit to the positive electrode. Under the current circumstance, high-capacity and large-sized cells of conventional lithium secondary cells have a short charge/discharge cycle lifetime, and the safeness and reliability thereof as consumer secondary cells cannot be considered sufficient.

### CITATION LIST

### Non-Patent Literature

Non-Patent Literature 1: M. Armand, J.-M. Tarascon, Nature 451, 652 (2008)

### DISCLOSURE OF INVENTION

### Technical Problem

The present invention is contemplated for providing a lithium cell, which is extremely useful as a consumer secondary cell that is excellent in elongation of lifetime of charge/discharge cycles, safeness, and reliability, by utilizing a reaction in which metals that are used along the respective surface of the negative electrode and positive electrode are dissolved and deposited along with charging and discharging, which lithium cell can prevent deterioration of cycles due to the volume expansion and breakage of the crystalline structure of an active material, which are seen in conventional lithium cells utilizing insertion of lithium ions into an active material and extraction of the lithium ions therefrom, which lithium cell can significantly increase the electrical capacity of the positive electrode, and which lithium cell can suppress a dendrite of metal lithium.

### Solution to Problem

The present inventors, having studied for a long time period intensively on a lithium secondary cell utilizing a novel reaction system, have found that a lithium secondary cell can be obtained, which is extremely useful as a consumer secondary cell that is excellent in elongation of a lifetime of charge/discharge cycles, safeness, and reliability, by utilizing a reaction in which metals that are used along the surfaces of the negative electrode and positive electrode, respectively, are dissolved and deposited along with charging and discharging, and by utilizing a solid electrolyte separator, which lithium cell can use, for example, metal copper, as a positive electrode material, that is readily available and stable and has a high electric capacity, without using a conventional active material, as an electrode material, that may cause the volume expansion and breakage of the crystalline structure due to insertion and extraction. The present invention is attained based on this finding.

That is, the present application is to provide the following inventions:

(1) A lithium secondary cell, having: a negative electrode, a negative electrode-electrolyte solution, a separator, a positive electrode-electrolyte solution, and a positive electrode, which are disposed in this order, wherein the separator is a solid electrolyte through which only lithium ions pass.
(2) The lithium secondary cell according to (1), wherein the solid electrolyte through which only lithium ions pass, is at least one selected from Li₃N, a Garnet-type lithium ion conductor, a NASICON-type lithium ion conductor LISICON, a Fe₂(SO₄)-type lithium ion conductor, a perovskite-type lithium ion conductor, a thio-LISICON-type lithium ion conductor, and a polymer-type lithium ion conductor.
(3) The lithium secondary cell according to (1) or (2), wherein the negative electrode is a material selected from metal lithium, graphite, hard carbon, silicon, and tin, and the negative electrode-electrolyte solution is an organic electrolyte solution.
(4) The lithium secondary cell according to (1) or (2), wherein the positive electrode is a material selected from metal copper, silver, iron, nickel, and gold, and the positive electrode-electrolyte solution is a water-soluble electrolyte solution.
(5) The lithium secondary cell according to any one of (1) to (4), wherein the positive electrode-electrolyte solution contains lithium ion at the first charging.
(6) The lithium secondary cell according to any one of (1) to (5), wherein the positive electrode-electrolyte solution contains an ion of a metal selected from metal copper, silver, iron, nickel, and gold at the first charging.
(7) The lithium secondary cell according to any one of (1) to (6), wherein only the lithium ions in the electrolyte solution at the side of the positive electrode transfer through the solid electrolyte to the electrolyte solution at the side of the negative electrode, when charging, and wherein only the lithium ions in the electrolyte solution at the side of the negative electrode transfer through the solid electrolyte to the electrolyte solution at the side of the positive electrode, when discharging.
(8) The lithium secondary cell according to any one of (1) to (7), wherein a dissolution reaction of: Cu=>Cu²⁺+2e⁻ occurs on the surface of the metal copper of the positive electrode, and a deposition reaction of: Li⁺+e⁻=>Li occurs on the surface of the metal lithium of the negative electrode, when charging, and wherein a deposition reaction of: Cu²⁺+2e⁻=>Cu occurs on the surface of the metal copper of the positive electrode, and a dissolution reaction Li=>Li⁺+e⁻ occurs on the surface of the metal lithium of the negative electrode, when discharging.
(9) The lithium secondary cell according to any one of (1) to (7), wherein a dissolution reaction of: M=>M⁺+e⁻ occurs on the surface of metal M of the positive electrode, in which M is a material selected from silver, iron, nickel, and gold, and a deposition reaction of: Li⁺+e⁻=>Li occurs on the surface of the metal lithium of the negative electrode, when charging, and wherein a deposition reaction of: M⁺+e⁻=>M occurs on the surface of the metal M of the positive electrode, and a dissolution reaction of: Li=>Li⁺+e⁻ occurs on the surface of the metal lithium of the negative electrode, when discharging.

### Advantageous Effects of Invention

By utilizing a reaction in which metals that are used along the respective surface of the negative electrode and positive electrode are dissolved and deposited along with charging and discharging, the lithium secondary cell of the present invention can prevent deterioration of cycles due to the volume expansion and breakage of the crystalline structure of the active material, which are observed in conventional lithium cells utilizing insertion of lithium ions into an active material and extraction of the lithium ions therefrom.

Further, since metal copper or the like that is high in electric capacity can be used as a positive electrode material, instead of conventional composite oxides low in electric capacity, such as LiCoO₂, LiNiO₂, LiNi_{1/3}Mn_{1/3}Co_{1/3}O₂, LiMn₂O₄, LiFePO₄, LiMnPO₄, and LiCoPO₄, the electric capacity of the active material of the positive electrode can be, for example, 843 mAh/g that is 5 to 6 times that of conventional LiCoO₂ (=130 mAh/g).

Thus, the lithium secondary cell of the present invention has a positive electrode whose electric capacity is remarkably increased, and can suppress a dendrite of metal lithium, and thus is quite useful as a consumer secondary cell that is excellent in elongation of a lifetime of charge/discharge cycles, safeness, and reliability.

### BRIEF DESCRIPTION OF DRAWINGS

FIG. 1 is a drawing for explaining a lithium secondary cell of the present invention.

FIG. 2 is a conceptional drawing of the electrochemical reaction and the transfer of ion along with charging and discharging of a typical lithium secondary cell of the present invention.

FIG. 3 is a cyclic voltammetry (CV) curve of dissolution and deposition of a copper electrode of the lithium secondary cell obtained in Example 1.

FIG. 4 is a profile of charging/discharging of the lithium secondary cell obtained in Example 1.

FIG. 5 is a profile of charge/discharge cycles of the lithium secondary cell obtained in Example 1.

FIG. 6 is a graph showing the relationship between a discharging capacity and a coulombic efficiency by repeating charging/discharging (100 cycles) of the lithium secondary cell obtained in Example 1.

FIG. 7 is a profile of charging/discharging of the lithium secondary cell obtained in Example 2.

FIG. 8 is a conceptional drawing of the electrochemical reaction and transfer of ion along with charging and discharging of a conventional lithium secondary cell.

### BEST MODE FOR CARRYING OUT THE INVENTION

The lithium secondary cell of the present invention has: a negative electrode, a negative electrode-electrolyte solution, a separator, a positive electrode-electrolyte solution, and a positive electrode, which are disposed in this order, wherein the separator is a solid electrolyte through which only lithium ions pass.

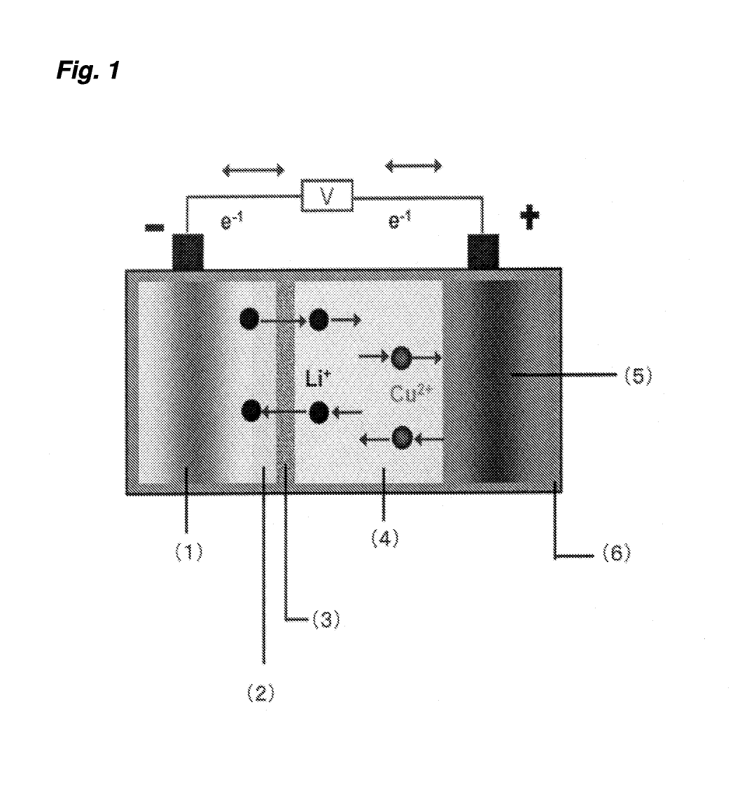

A typical lithium secondary cell of the present invention is shown in FIG. 1.

In FIG. 1, 1 represents a negative electrode, 2 represents an electrolyte solution of the negative electrode, 3 represents a separator, 4 represents an electrolyte solution of a positive electrode, 5 represents said positive electrode, and 6 represents an overall container.

Examples of the material that forms the negative electrode 1 include metal lithium, graphite, hard carbon, silicon, and tin. Among these, metal lithium is preferably used, in view of large capacity and cycle stability.

The electrolyte solution for a negative electrode area is not particularly limited, but it is necessary to use an organic electrolyte as the electrolyte solution, when metal lithium is used as the negative electrode.

The electrolyte to be contained in the electrolyte solution is not particularly limited as long as it forms lithium ions in the electrolyte solution. Examples include LiPF₆, LiClO₄, LiBF₄, LiAsF₆, LiAlCl₄, LiCF₃SO₃, LiSbF₆, and the like. These electrolytes may be used solely or in combination therewith.

Further, as the solvent for the electrolyte solution, any of solvents known as organic solvents of this kind can be used. Examples include propylene carbonate, tetrahydrofuran, dimethylsulfoxide, β-butyrolactone, 1,3-dioxolane, 4-methyl-1,3-dioxolane, 1,2-dimethoxyethane, 2-methyltetrahydrofuran, sulfolane, diethyl carbonate, dimethylformamide, acetonitrile, dimethyl carbonate, ethylene carbonate, and the like. These organic solvents may be used solely or in combination therewith.

3 is a solid electrolyte through which only lithium ions pass. The striking feature of the present invention is that such a solid electrolyte is applied to the lithium cell.

As the solid electrolyte through which only lithium ions pass that is used in the present invention, use may be made, for example, of Li₃N, a Garnet-type lithium ion conductor, a NASICON-type lithium ion conductor, a Fe₂(SO₄)-type lithium ion conductor, a perovskite-type lithium ion conductor, a thio-LISICON-type lithium ion conductor, a polymer-type lithium ion conductor, and the like.

In the case where a usual separator or an ion exchange membrane through which cations pass is used instead of such a solid electrolyte through which only lithium ions pass, a desired lithium secondary cell as in the present invention cannot be obtained, because not only lithium ions but also copper ions, hydrogen ions, and the like may pass through the separator or membrane, to allow a reaction with the metal lithium in the negative electrode, thereby to deposit copper on the negative electrode or to release a large amount of hydrogen.

Examples of a material of the positive electrode 5 include copper, iron, nickel, silver, gold, and the like. Among these, metal copper is preferably used, in view of stability and large capacity.

As the positive electrode-electrolyte solution 4, use may be made of any of an organic electrolyte, a water-soluble electrolyte, or an electrolyte solution of an ionic liquid. It is preferable to use a water-soluble electrolyte solution in view of low costs.

As the electrolyte to be contained in the water-soluble electrolyte solution, preferably use may be made of an electrolyte that forms lithium ions in the electrolyte solution. Examples of the electrolyte include LiNO₃, LiCl, Li₂SO₄, and the like. These electrolytes may be used solely or in combination therewith.

The electrolyte is not particularly limited as long as it forms ions with the metal utilized for the positive electrode in the lithium ion electrolyte solution.

Next, explanation will be made of the charge/discharge process of the lithium secondary cell of the present invention, in which metal lithium is used for the negative electrode, an organic electrolyte is used for the negative electrode-electrolyte solution, metal copper is used for the positive electrode, an electrolyte solution of an aqueous solution is used for the positive electrode-electrolyte solution, and a solid electrolyte is used between the negative electrode-electrolyte solution and the positive electrode-electrolyte solution.

### [Charge]

Li⁺+e⁻=>Li (negative electrode),Cu=>Cu²⁺+2e⁻ (positive electrode)

That is, the Li+ in the solution in the positive electrode area transfers to the negative electrode area, through the solid electrolyte.

### [Discharge]

Li=>Li⁺+e⁻ (negative electrode),Cu²⁺+2e⁻=>Cu (positive electrode)

That is, the Li⁺ in the solution in the negative electrode area transfers to the positive electrode area, through the solid electrolyte.

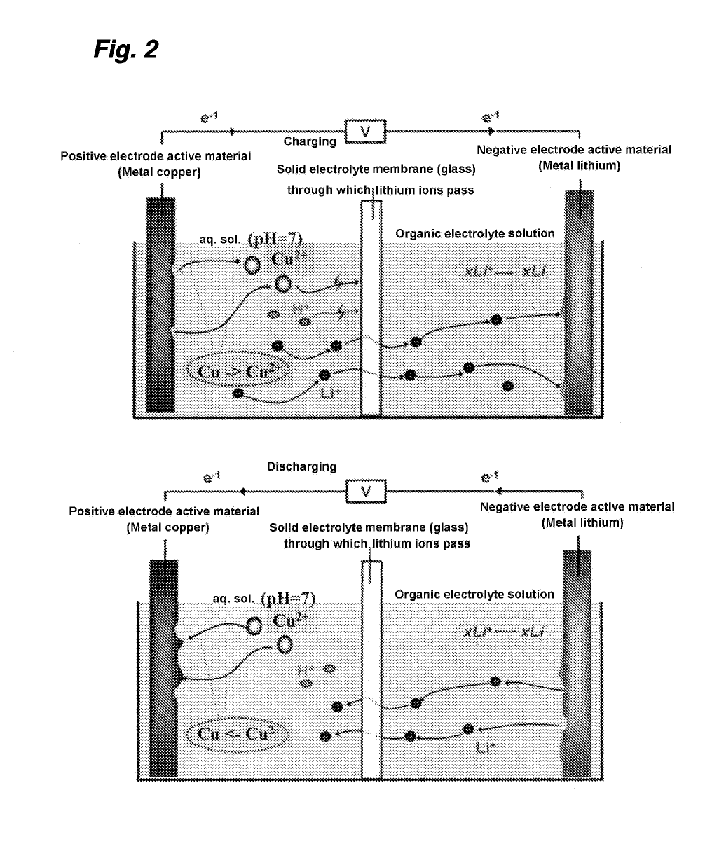

The specific aspect thereof is shown in FIG. 2.

Although metal copper is used in the positive electrode in the above-mentioned example, the lithium secondary cell of the present invention can also be obtained by the following charge/discharge reaction, in the cases where silver, iron, nickel, gold, or the like is used instead of the metal copper. An example using silver is explained herein.

### [Charge]

Li⁺+e⁻=>Li (negative electrode),Ag=>Ag⁺+e⁻ (positive electrode)

That is, the Li+ in the solution in the positive electrode area transfers to the negative electrode area, through the solid electrolyte.

### [Discharge]

Li=>Li⁺+e⁻ (negative electrode),Ag⁺+e⁻=>Ag (positive electrode)

That is, the Li⁺ in the solution in the negative electrode area transfers to the positive electrode area, through the solid electrolyte.

Further, although metal lithium is used in the negative electrode in the above-mentioned example, the lithium secondary cell of the present invention can also be obtained by the following charge/discharge reaction, in the cases where graphite, hard carbon, silicon, tin, or the like is used instead of the metal lithium. An example using hard carbon is explained herein.

### [Charge]

Li⁺+6C+e⁻=>LiC₆ (negative electrode),Cu=>Cu²⁺+2e⁻ (positive electrode)

That is, the Li⁺ in the solution in the positive electrode area transfers to the negative electrode area, through the solid electrolyte.

### [Discharge]

LiC₆=>Li⁺+6C+e⁻ (negative electrode),Cu²⁺+2e⁻=>Cu (positive electrode)

That is, the Li⁺ in the solution in the negative electrode area transfers to the positive electrode area, through the solid electrolyte.

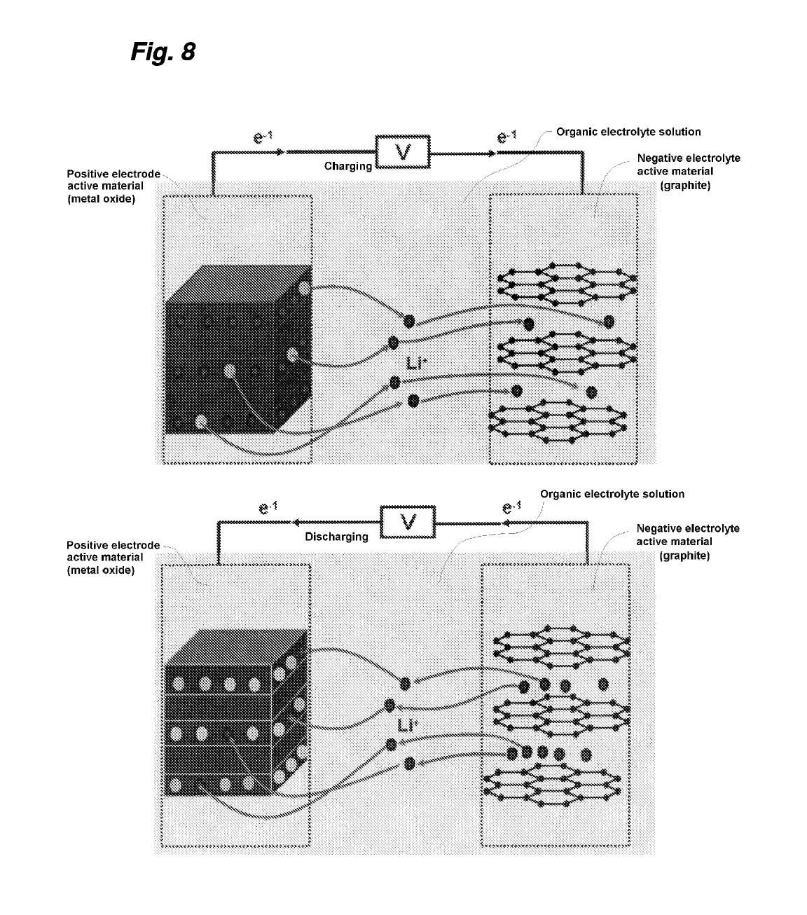

Contrary to the above, as shown in FIG. 8, in a conventional lithium ion cell, along with charging, the lithium ions are extracted from the layer active material of the positive electrode, to become lithium ions, and the resultant lithium ions are inserted into the layer active material of the negative electrode, whereas the lithium ions move conversely in discharging, that is, the lithium ions are extracted from the layer active material of the negative electrode, to become lithium ion, and the resultant lithium ions are inserted into the layer active material of the positive electrode.

Thus, the novel lithium secondary cell of the present invention has following advantages, since it utilizes an innovative concept, as compared to the systems of conventional lithium ion cells in which only lithium ions transfer from a negative electrode to a positive electrode, or from the positive electrode to the negative electrode.

1) The active material of the positive electrode is high in capacity, which is about 6 to 7 times that of currently-used LiCoO₂ (=130 mAh/g).

2) Since an electrolyte solution of an aqueous solution is used at the side of the positive electrode, there is no problem of firing due to heat generated.

3) Along with charging and discharging, dissolution/deposition reactions occur along the surfaces of the negative electrode and positive electrode, and the reactions are not conventional insertion and extraction; thus, deterioration of cycles due to the volume expansion and breakage of the crystalline structure is little.

4) Since electrolyte solutions that are respectively suitable for the negative electrode area and positive electrode area are utilized, it is not necessary to tolerate a broad potential, and thus selection of the electrolyte solutions becomes readily.

5) Since the solid electrolyte is disposed between the negative electrode and positive electrode, a dendrite of lithium and copper can be suppressed, and safeness is also improved.

### EXAMPLES

Hereinafter, the present invention will be described in more detail with reference to the examples given below.

### Example 1

In the device shown in FIG. 1, a lithium cell was prepared, by using a metal lithium ribbon as a negative electrode 1, 1.5 ml of an organic electrolyte in which 1 M of LiClO₄ had been dissolved (EC/DEC) as a negative electrode-electrolyte solution 2, a lithium ion solid electrolyte (a NASICON-type lithium ion conductor LISICON: 0.15 mm, ion conductivity 2×10⁻⁴ S/cm²) as a separator 3, 1.5 ml of a 2-M aqueous LiNO₃ solution as a positive electrode-electrolyte solution 4, a metal copper as a positive electrode 5, and a glass cell as a container 6, and a charge/discharge test was conducted.

When the cell is charged, the copper in the metal copper ribbon is dissolved in the aqueous solution (Cu=>Cu²⁺+2e⁻). At the same time, the Li⁺ existing in the aqueous solution transfers to the side of the organic electrolyte solution, through the glass substrate of the lithium ion solid electrolyte. At the same time, the Li⁺ existing in the organic electrolyte solution is deposited on the surface of the metal lithium ribbon (Li⁺+e⁻=>Li). When the cell is discharged, the lithium in the metal lithium ribbon is dissolved in the organic electrolyte solution (Li=>Li⁺+e⁻). At the same time, the Li⁺ existing in the organic electrolyte solution transfers to the side of the aqueous solution, through the glass substrate of the lithium ion solid electrolyte. At the same time, the Cu²⁺ that has been dissolved at the side of the aqueous solution in the charging is deposited on the surface of the metal copper ribbon (Cu⁺+2e⁻=>Cu).

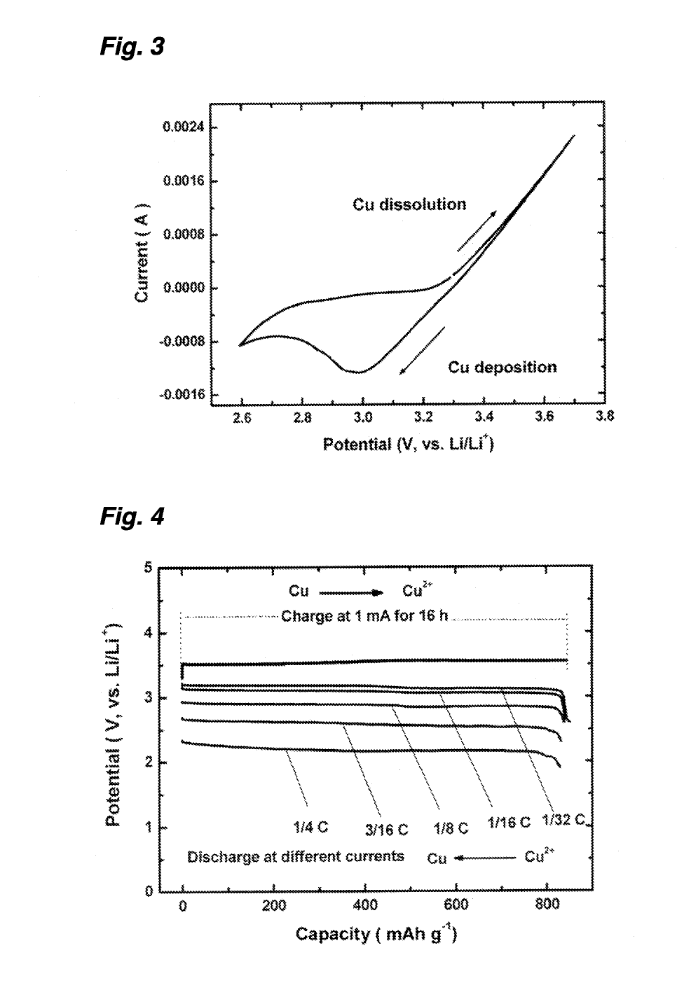

The cyclic voltammetry (CV) curve diagram of the dissolution and deposition of the copper electrode in the aqueous solution is shown in FIG. 3. In FIG. 3, when the redox potential (Li/Li⁺) of the lithium ions is referred to, the range of the potential in the graph at scanning speed 2 mV/s, was 2.6 to 3.7 V Li/Li⁺; thus, it is evident from the above that the dissolution of copper occurred on the upper right and the deposition of copper occurred on the lower left.

Further, in order to measure the charge/discharge profile of this cell, the cell was charged at a current of 1 mA over 16 hours, and discharged at the respective discharge rate (0.5 mA, 1 mA, 2 mA, 3 mA, 4 mA). The result of the charge/discharge profile is shown in FIG. 4. The ¼C to 1/32C in FIG. 4 represent the discharge rates at 4 mA to 0.5 mA, respectively. It is found from FIG. 4 that this cell had a discharge capacity of 843 mAh/g that is approximately equal to a theoretical volume, without depending on the discharge rate.

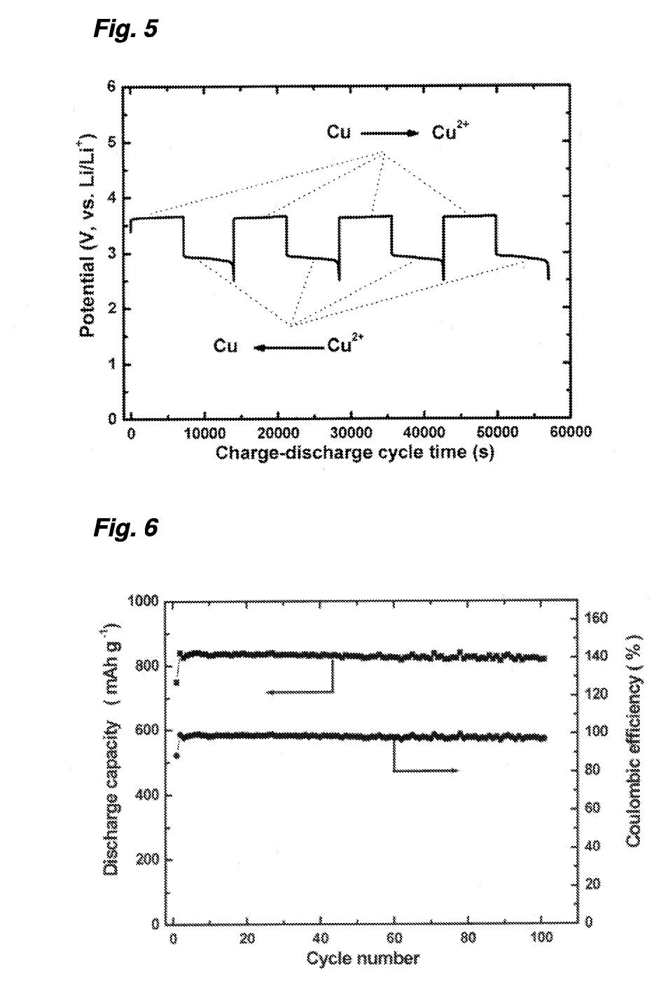

Next, in order to measure the profile of the charge/discharge cycles of this cell, the cell was charged at a current of 2 mA over 2 hours, and discharged at a current of 2 mA, and these operations were repeated. The result of the charge/discharge cycles is shown in FIG. 5, and the discharge capacities and coulombic efficiencies thereof upon the repeated 100 cycles are shown in FIG. 6.

From FIGS. 5 and 6, it is understood that the discharge potential and discharge capacity are not deteriorated, even charging and discharging are repeated.

### Example 2

In the device shown in FIG. 1, a lithium cell was prepared, by using a metal lithium ribbon as a negative electrode 1, 1.5 ml of an organic electrolyte in which 1 M of LiClO₄ had been dissolved (EC/DEC) as a negative electrode-electrolyte solution 2, a lithium ion solid electrolyte (a NASICON-type lithium ion conductor LISICON: 0.15 mm, ion conductivity 2×10⁻⁴ S/cm²) as a separator 3, 1.5 ml of a 2-M aqueous LiNO₃ solution as a positive electrode-electrolyte solution 4, and a metal silver as a positive electrode 5, and a charge/discharge test was conducted.

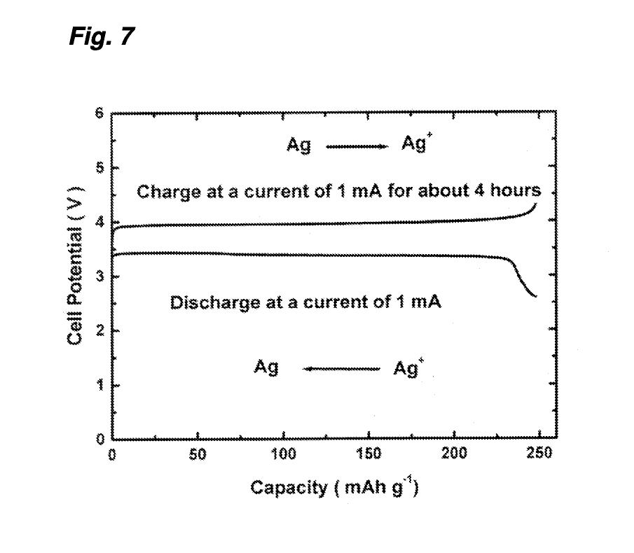

Next, in order to measure the profile of the charge/discharge cycles of this cell, the cell was charged at a current of 2 mA over 2 hours, and discharged at a current of 2 mA, and these operations were repeated. The result of the charge/discharge profile is shown in FIG. 7. From FIG. 7, it is found that this cell had a discharge capacity of 248 mAh/g that is approximately equal to a theoretical volume, without depending on the discharge rate.

1-9. (canceled)

10. A lithium secondary cell, comprising:
a negative electrode;
a negative electrode-electrolyte solution;
a separator;
a positive electrode-electrolyte solution; and
a positive electrode,
which are disposed in this order,
wherein the separator is a solid electrolyte through which only lithium ions pass.

11. The lithium secondary cell according to claim 10, wherein the negative electrode is a material selected from the group consisting of metal lithium, graphite, hard carbon, silicon, and tin, and the negative electrode-electrolyte solution is an organic electrolyte solution.

12. The lithium secondary cell according to claim 10, wherein the positive electrode is a material selected from the group consisting of metal copper, silver, iron, nickel, and gold, and the positive electrode-electrolyte solution is a water-soluble electrolyte solution.

13. The lithium secondary cell according to claim 10, wherein the positive electrode-electrolyte solution contains lithium ion at the first charging.

14. The lithium secondary cell according to claim 10, wherein the positive electrode-electrolyte solution contains an ion of a metal selected from the group consisting of metal copper, silver, iron, nickel, and gold at the first charging.

15. The lithium secondary cell according to claim 10, wherein only the lithium ions in the electrolyte solution at the side of the positive electrode transfer through the solid electrolyte to the electrolyte solution at the side of the negative electrode, when charging, and wherein only the lithium ions in the electrolyte solution at the side of the negative electrode transfer through the solid electrolyte to the electrolyte solution at the side of the positive electrode, when discharging.

16. The lithium secondary cell according to claim 10, wherein a dissolution reaction of Cu=>Cu²⁺+2e⁻ occurs on the surface of the metal copper of the positive electrode, and a deposition reaction of: Li⁺+e⁻=>Li occurs on the surface of the metal lithium of the negative electrode, when charging, and wherein a deposition reaction of: Cu²⁺+2e⁻=>Cu occurs on the surface of the metal copper of the positive electrode, and a dissolution reaction Li=>Li⁺+e⁻ occurs on the surface of the metal lithium of the negative electrode, when discharging.

17. The lithium secondary cell according to claim 10, wherein a dissolution reaction of M=>M⁺+e⁻ occurs on the surface of metal M of the positive electrode, in which M is a material selected from the group consisting of silver, iron, nickel, and gold, and a deposition reaction of Li⁺+e=>Li occurs on the surface of the metal lithium of the negative electrode, when charging, and wherein a deposition reaction of: M⁺+e⁻=>M occurs on the surface of the metal M of the positive electrode, and a dissolution reaction of: Li=>Li⁺+e⁻ occurs on the surface of the metal lithium of the negative electrode, when discharging.

18. The lithium secondary cell according to claim 10, wherein the solid electrolyte through which only lithium ions pass, is at least one selected from the group consisting of Li₃N, a Garnet-type lithium ion conductor, a NASICON-type lithium ion conductor LISICON, a Fe₂(SO₄)-type lithium ion conductor, a perovskite-type lithium ion conductor, a thio-LISICON-type lithium ion conductor, and a polymer-type lithium ion conductor.

19. The lithium secondary cell according to claim 18, wherein the positive electrode is a material selected from the group consisting of metal copper, silver, iron, nickel, and gold, and the positive electrode-electrolyte solution is a water-soluble electrolyte solution.

20. The lithium secondary cell according to claim 18, wherein the negative electrode is a material selected from the group consisting of metal lithium, graphite, hard carbon, silicon, and tin, and the negative electrode-electrolyte solution is an organic electrolyte solution.

21. The lithium secondary cell according to claim 20, wherein the positive electrode is a material selected from the group consisting of metal copper, silver, iron, nickel, and gold, and the positive electrode-electrolyte solution is a water-soluble electrolyte solution.

22. The lithium secondary cell according to claim 21, wherein the positive electrode-electrolyte solution contains lithium ion at the first charging.

23. The lithium secondary cell according to claim 21, wherein the positive electrode-electrolyte solution contains an ion of a metal selected from the group consisting of metal copper, silver, iron, nickel, and gold at the first charging.

24. The lithium secondary cell according to claim 21, wherein only the lithium ions in the electrolyte solution at the side of the positive electrode transfer through the solid electrolyte to the electrolyte solution at the side of the negative electrode, when charging, and wherein only the lithium ions in the electrolyte solution at the side of the negative electrode transfer through the solid electrolyte to the electrolyte solution at the side of the positive electrode, when discharging.

25. The lithium secondary cell according to claim 21, wherein a dissolution reaction of: Cu=>Cu²⁺+2e⁻ occurs on the surface of the metal copper of the positive electrode, and a deposition reaction of: Li⁺+e⁻=>Li occurs on the surface of the metal lithium of the negative electrode, when charging, and wherein a deposition reaction of Cu²⁺+2e⁻=>Cu occurs on the surface of the metal copper of the positive electrode, and a dissolution reaction Li=>Li⁺+e⁻ occurs on the surface of the metal lithium of the negative electrode, when discharging.

26. The lithium secondary cell according to claim 21, wherein a dissolution reaction of: M=>M⁺+e⁻ occurs on the surface of metal M of the positive electrode, in which M is a material selected from the group consisting of silver, iron, nickel, and gold, and a deposition reaction of: Li⁺+e⁻=>Li occurs on the surface of the metal lithium of the negative electrode, when charging, and wherein a deposition reaction of: M⁺+e⁻=>M occurs on the surface of the metal M of the positive electrode, and a dissolution reaction of: Li=>Li⁺+e⁻ occurs on the surface of the metal lithium of the negative electrode, when discharging.
